(19) United States
(12) Patent Application Publication
(10) Pub. No.: US 2014/0171107 A1
(43) Pub. Date: Jun. 19, 2014

(54) SYSTEM AND METHOD FOR WIRELESS INDOOR LOCALIZATION BASED ON INERTIAL MEASUREMENT UNIT AND MAP INFORMATION

(71) Applicant: INDUSTRIAL TECHNOLOGY RESEARCH INSTITUTE, (US)

(72) Inventors: Yung-Wei KAO, Taipei City (TW); Sheng-An CHANG, Pingtung City (TW); Lun-Chia KUO, Taichung City (TW)

(73) Assignee: INDUSTRIAL TECHNOLOGY RESEARCH INSTITUTE, Hsinchu (TW)

(21) Appl. No.: 13/847,932

(22) Filed: Mar. 20, 2013

(30) Foreign Application Priority Data
Dec. 19, 2012 (TW) 101148480

(51) Int. Cl. G01S 5/10

(52) U.S. Cl. CPC G01S 5/10
USPC 455/456.1

(57) ABSTRACT

An embodiment disclosing a wireless indoor localization system based on inertial measurement unit (IMU) and map information, including at least a mobile wireless signal transceiving device able to compute, with each including at least a wireless signal transceiver and at least an IMU for collecting environmental information measured by mobile device; at least two fixed wireless signal transceiving devices, configured to provide wireless signal for positioning or wireless signal observation; at least a wireless signal observation device, configured to observe signal strength of fixed signal transceiving devices; at least a training database, configured to store at least a standard comparison information; at least a map information, including indoor spatial description, configured to assist in determining feasibility of movement at continuous time; and at least a computing core unit, configured to compute positioning result based on collected information during training and positioning phases, and comparison with map information.

### CROSS-REFERENCE TO RELATED APPLICATION

The present application is based on, and claims priority form, Taiwan Patent Application No. 101148480, filed Dec. 19, 2012, the disclosure of which is hereby incorporated by reference herein in its entirety.

### TECHNICAL FIELD

The technical field generally relates to a system and method for wireless indoor localization based on inertial measurement unit (IMU) and map information.

### BACKGROUND

The popularity of smart mobile devices greatly increases the penetration of 3G/WiFi wireless network as well as the demands of the wireless network deployment and related applications. In addition to games and social network, another important application on the smart mobile device is positioning and the derived applications, such as, personal navigation and location-based service (LBS). The positioning systems are widely categorized as: outdoor positioning system (or global positioning system, GPS) and indoor positioning system (or indoor localization system). In indoor positioning system, wireless equipment such as WiFi AP can be deployed indoors where satellite signals are hard to reach. Hence, wireless positioning technology becomes the mainstream technique for indoor localization systems.

The common wireless signal indoor positioning means mainly include triangulation method based on signal attenuation model, probability model method based on statistics, and pattern matching method based on machine learning. The triangulation method and probability model method may incur bigger positioning error due to difference in indoor environments, and therefore, the majority of positioning systems use pattern matching for positioning. However, regardless of which of the above methods is adopted, the signals transmitted by the wireless signal transmitter must be stable and cannot vary over time. Nevertheless, in practice, the signals from the wireless signal transmitter can be measured to have different strength due to the low quality and the instability of transmitter, which leads to low precision in positioning. The triangulation method must take the environmental factor into account of the attenuation model and adjusts the parameters accordingly. The pattern matching method must re-establish training database. However, the actual indoor environment makes the selection of a single attenuation model impossible, even with adjusted parameters. The re-establishing training database is unable to reflect the real-time signal change. Besides wireless signal transceiver, the mobile devices currently available are usually equipped with different inertial measurement units (IMU), such as, electronic compass. The conventional indoor positioning system often does not engage IMUs and map information to assist in indoor positioning. In addition, although electronic compass is able to provide orientation information, the measurement accuracy is easily affected by the indoor layout or furnishing which affects the magnetic field. Hence, the usability of electronic compass is severely affected.

### SUMMARY

The embodiments of the present disclosure provide a system and method for wireless signal indoor localization, and more specifically, a system and method for wireless indoor localization based on IMU and map information.

An exemplary embodiment describes a system for wireless indoor localization based on IMU and map information. The system includes: at least a mobile wireless signal transceiving device able to execute computation, with each device including with each including at least a wireless signal transceiver and at least an IMU for collecting wireless signal strength measured by the mobile device and information of own environment information; at least two fixed wireless signal transceiving devices, configured to provide wireless signal for positioning; at least a wireless signal observation device, configured to observe signal strength of fixed signal transceiving devices; at least a training database, configured to store at least a standard matching information; at least a map information, including indoor spatial description, configured to assist in determining feasibility of movement at continuous time; and at least a computing core unit, configured to establish training database during training phase, and compute positioning results based on collected information and map information during positioning phases.

Another embodiment describes a method for wireless indoor localization based on IMU and map information, including: a training phase, further including a manager establishing map information and programming orientation axis, coordination system and training positions; at each training position, the mobile wireless signal transceiving device collects the strengths of wireless signals and IMU information measured in different directions and transmits the measured results to a training database for recording; and the wireless signal observation device scans the signal strength of the fixed wireless signal transceiving devices and transmits the scan results to a computing core; and a positioning phase, further including: a user activating a positioning program on the mobile wireless signal transceiving device and transmitting wireless signal strength and IMU information at the instant of time to the computing core unit; after receiving wireless signal strength and IMU information, the computing core unit performing signal correction and displacement detection, and performing orientation correction and positioning algorithm to shrink the candidate location set according to the processed information, pattern history, and map information, then identify the location of the user; and transmitting identified location to the positioning program on the mobile wireless signal transceiving device for display.

The foregoing will become better understood from a careful reading of a detailed description provided herein below with appropriate reference to the accompanying drawings.

### BRIEF DESCRIPTION OF THE DRAWINGS

The embodiments can be understood in more detail by reading the subsequent detailed description in conjunction with the examples and references made to the accompanying drawings, wherein:

FIG. 1 shows a schematic view of the structure of a system for wireless indoor localization based on IMU and map information according to an exemplary embodiment;

FIG. 2 shows a schematic view of information flow of collecting information by the mobile wireless signal transceiving device in training phase;

FIG. 3 shows a schematic view of information flow of the wireless signal observation device scanning signal strength of the fixed wireless signal transceiving device;

FIG. 4 shows a schematic view of information flow of the mobile wireless signal transceiving device scanning the fixed wireless signal transceiving device and retrieving the positioning result from server in positioning phase;

FIG. 5 shows a schematic view of information flow of the fixed wireless signal transceiving device scanning the mobile wireless signal transceiving device in positioning phase;

FIG. 6 shows a flowchart of the method for wireless indoor localization based on IMU and map information according to an exemplary embodiment;

FIG. 7 shows a schematic view of the orientation of the Earth, user-defined orientation and orientation error in the method of the present disclosure;

FIG. 8 shows a schematic view of computation of axis of user-defined orientation in the method of the present disclosure;

FIG. 9 shows a schematic view of the orientation correction in the method of the present disclosure;

FIG. 10 shows a flowchart of a method of history matching with candidate location set shrinking according to the present disclosure;

FIG. 11 shows a schematic view of an indoor scenario of walking straight forward according to the embodiment of the present disclosure;

FIG. 12 shows a result of step 1001 deleting unreasonable candidate locations according to the embodiment of the present disclosure;

FIG. 13 shows a result of history matching computing in the scenario of walking straight forward according to the embodiment of the present disclosure;

FIG. 14 shows a schematic view of an indoor scenario of making a turn according to the embodiment of the present disclosure;

FIG. 15 shows a result of step 1003 deleting unreasonable candidate locations according to the embodiment of the present disclosure; and

FIG. 16 shows a result of history matching computing in the scenario of making a turn according to the embodiment of the present disclosure.

### DETAILED DESCRIPTION OF THE DISCLOSED EMBODIMENTS

In the following detailed description, for purpose of explanation, numerous specific details are set forth in Order to provide a thorough understanding of the disclosed embodiments. It will be apparent, however, that one or more embodiments may be practiced without these specific details. In other instances, well-known structures and devices are schematically shown in order to simplify the drawing.

The present disclosure is related to a system and method for wireless indoor localization based on inertial measurement unit (IMU) and map information.

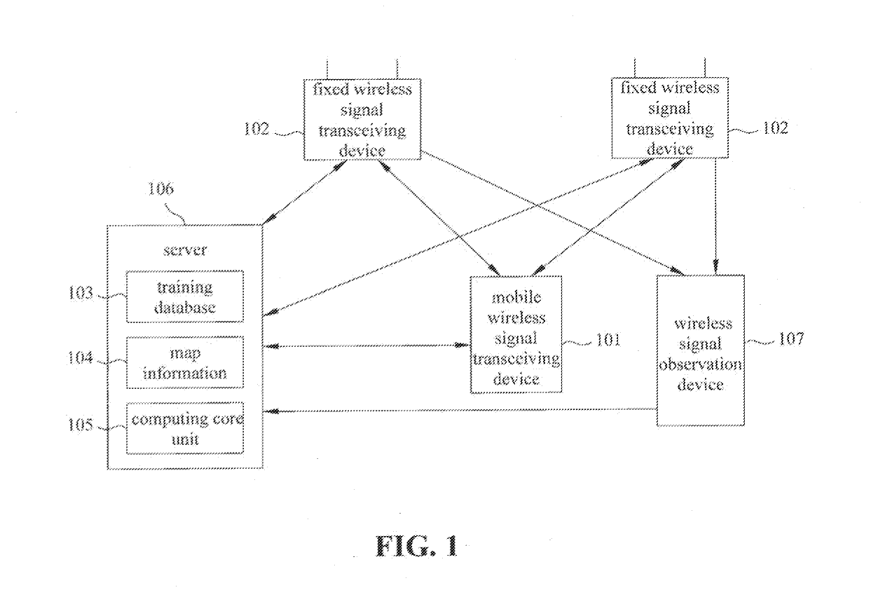

FIG. 1 shows a schematic view of the structure of a system for wireless indoor localization based on IMU and map information according to an exemplary embodiment. As shown in FIG. 1, the system of the present disclosure includes: at least a mobile wireless signal transceiving device 101 able to execute computation, with each device 101 including with each including at least a wireless signal transceiver and at least an IMU for collecting wireless signal strength measured by the mobile device and information of own movement signal; at least two fixed wireless signal transceiving devices 102, configured to provide wireless signal for positioning; at least a wireless signal observation device 107, configured to observe signal strength of fixed signal transceiving devices; at least a training database 103, configured to store at least a standard comparison information; at least a map information 104, including indoor spatial description, configured to assist in determining feasibility of movement at continuous time; and at least a computing core unit 105, configured to compute positioning result based on collected information during training and positioning phases, and comparison with map information.

It should be noted that the computing core unit 105 performs a plurality of pattern matching based on features, such as, wireless signal strength, orientation angles, magnetometer reading, gyroscope reading and accelerometer reading, and so on, of current and previous historic patterns, and determines the location of the mobile wireless signal transceiving device 101 based on a candidate location with closest pattern, wherein the selected candidate location can be determined by deleting unseasonable candidate locations by the computing core unit 105 using related information, such as, map information, in moving and orientation information so as to improve positioning accuracy. The computing core unit 105 can execute on a server 106, or on the mobile wireless signal transceiving device 101. The execution is similar, except that when executing on the mobile wireless signal transceiving device 101, the required database 103 and map information 104 will also be stored in the mobile wireless signal transceiving device 101; when executing on the server 104, the required map information 104 is also stored in the server 106. However, when executing on the server 106, the training database 103 can be stored in the server 106 or in a separate server. In the following embodiment, the computing core unit 105 is on the server 106. In addition, the wireless signal transmitted and received by the fixed wireless signal transceiving device 102 or the mobile wireless signal transceiving device 101 can be WiFi, Bluetooth, RFID, Zigbee or other wireless signal with measurable signal strength, wherein the wireless signal observation device 107 can be access point, router or tag, and no specific restriction is imposed here. Also, the wireless signal observation device can also be a fixed wireless signal transceiving device 102 providing wireless signals.

The operation of the system for wireless indoor localization based on IMU and map information of the present disclosure includes a training phase and a positioning phase. In the training phase, the wireless signal observation device 107 observes and records the signal strength of the fixed wireless signal transceiving device 102, and performs the same observation in the positioning phase. In the positioning phase, the computing core unit 105 dynamically corrects the signal strength measured by the mobile wireless signal transceiving device 101 or recorded in the training database based on the observation result of the wireless signal observation device 107 in the training phase and the positioning phase. In addition, when establishing the training database 103, the orientation angle, expected orientation angle or the displacement of the above two is computed based on the IMU information, and recorded. During positioning, the current orientation angle of the mobile wireless signal transceiving device 101 is dynamically corrected based on the wireless signal matching result. Finally, the corrected signal strength, orientation angle and information computed by the IMU, such as, number of steps, step distance, turning or not and relation with the map information, are used in combination with historic records to filter candidate positions not matching the conditions in a selection mechanism. The following describes the operation of the system in details.

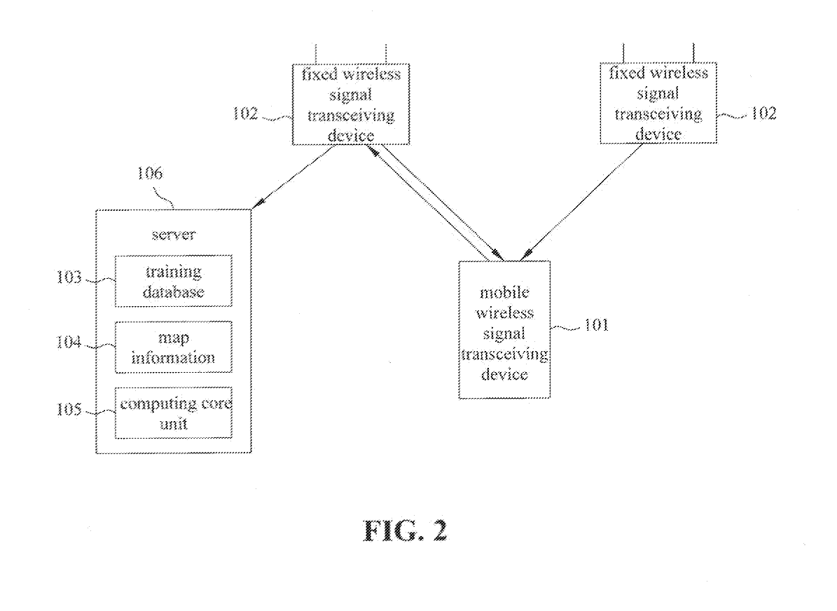

FIG. 2 shows a schematic view of information flow of collecting information by the mobile wireless signal transceiving device 101 in training phase. Before using the system, the system must program a plurality of training locations required for collecting patterns for matching, and uses the mobile wireless signal transceiving device 101 to perform a plurality of training data collections at the same or different angles at each of the training locations. The collected data includes the wireless signal strength for positioning provided by the environment and the information measured by the IMUs of the mobile wireless signal transceiving device 101. As shown in FIG. 2, the mobile wireless signal transceiving device 101 transmits the measured wireless signal transmitted by fixed wireless signal transceiving devices 102 and measured information by the IMUs to the server 106 directly or indirectly through a fixed wireless signal transceiving device 102 for storage and recording in the training database 103.

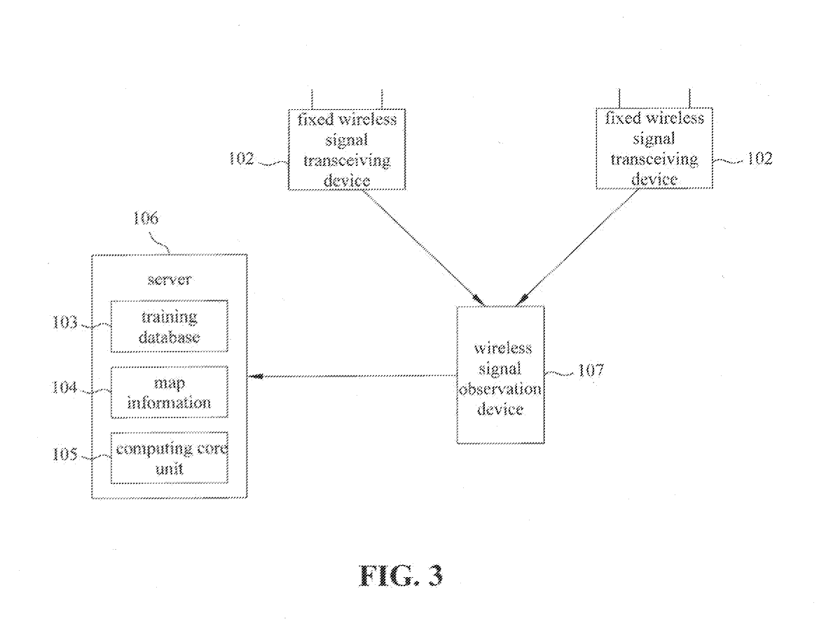

FIG. 3 shows a schematic view of information flow of the wireless signal observation device 107 scanning signal strength of the fixed wireless signal transceiving device 102. In training phase, in addition to the mobile wireless signal transceiving device 101 collecting training data, each wireless signal observation device 107 also observes the signal strength of the wireless signal transmitted by each fixed wireless signal transceiving device 102 and transmits the values of a plurality of measurements to the server 106 for storage and recording in the training database 103. Because signal strength observed at different times may be different, the observed values at different times are stored respectively, such as, observed values corresponding to morning, noon and evening.

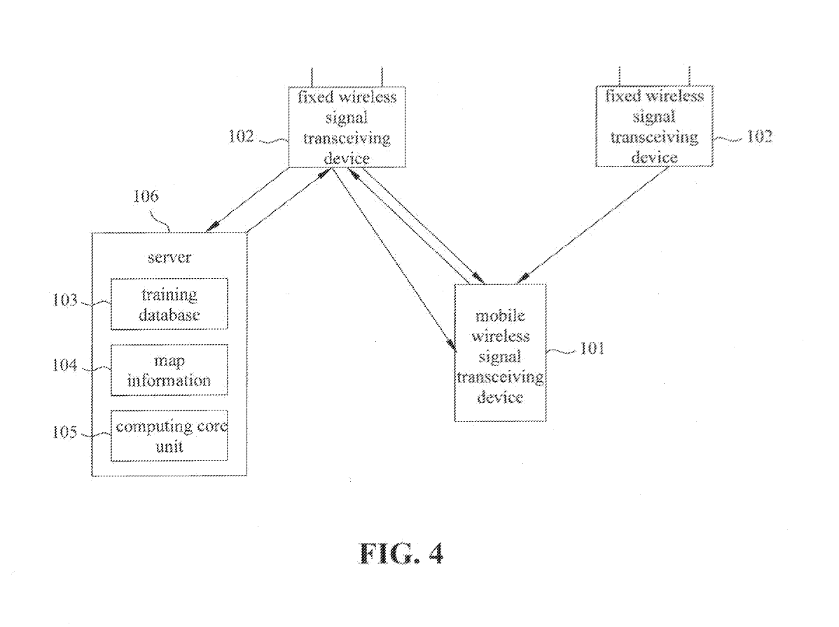

FIG. 4 shows a schematic view of information flow of the mobile wireless signal transceiving device 101 scanning the fixed wireless signal transceiving device 102 in positioning phase. After the training phase is over or the training database 103 is established, the positioning program on the mobile wireless signal transceiving device 101 starts to collect and transmit signal strength of the wireless signals in the current environment and the information of acceleration, orientation and rotation angle measured by the IMUs to the server 106 (using execution on the server 106 as example) as the information required for identifying location. In the mean time, each wireless signal observation device 107 continues to observe the signal strength of each fixed wireless signal transceiving device 102 and reports to the computing core unit 105 of the server 106. At this point, the result observed by the wireless signal observation device 107 can be stored in the training database 103, and retrieved from the training database 103 by the computing core unit 105. Alternatively, the observation results can be transmitted by the wireless signal observation device 107 to the computing core unit 105, or the computing core unit 105 can retrieve the observation result from the wireless signal observation device 107. After the computing core unit 105 obtains the observation result, the computing core unit 105 performs pattern patching on the dynamically collected observation information by the wireless signal observation device 107 against the observation information collected in the training phase, and dynamically performs correction on the measured signal strength of the mobile wireless signal transceiving device 101 or recorded signal strength in the training database 103.

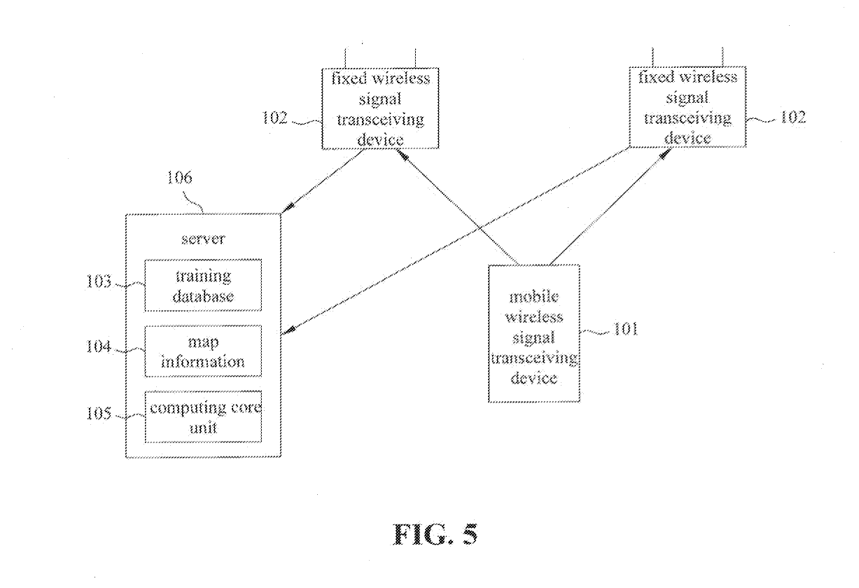

FIG. 5 shows a schematic view of information flow of the fixed wireless signal transceiving device 102 scanning the mobile wireless signal transceiving device 101 in positioning phase. Under certain circumstance, the mobile wireless signal transceiving device 101 of certain specific manufacturer may be unable to scan the fixed wireless signal transceiving device 102. For example, in version after iOS 4, the iPhone and iPad are prohibited to scan WiFi AP signal strength. Therefore, the present disclosure also provides a positioning method by using the fixed wireless signal transceiving device 102 to scan the mobile wireless signal transceiving device 101. As shown in FIG. 5, the fixed wireless signal transceiving device 102 scans the mobile wireless signal transceiving device 101 and transmits the scanned result to the server 106.

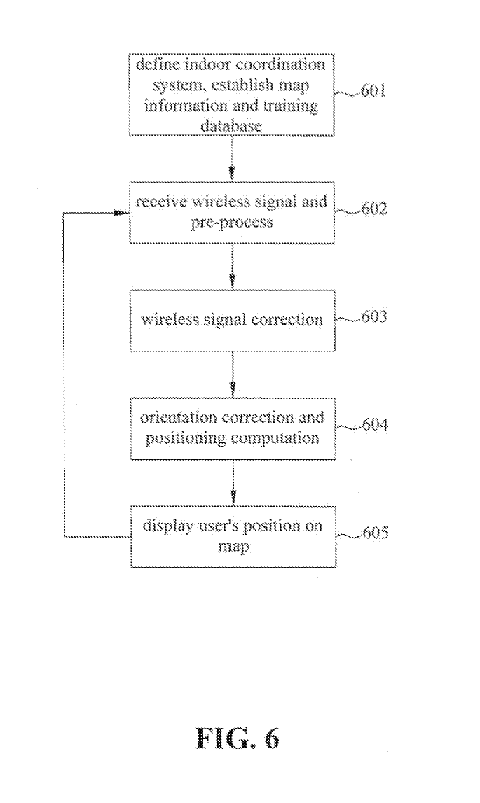

FIG. 6 shows a flowchart of the method for wireless indoor localization based on IMU and map information according to an exemplary embodiment. As shown in FIG. 6, step 601 is the training phase. The manager of the environment or the building must draw indoor spatial map, establish map information and programming orientation axis, coordination system and training positions; followed by, at each training position, collecting and transmitting wireless signals measured in different directions and IMU information by the mobile wireless signal transceiving device 101 to a training database 103 for recording; and transmitting signal strength of the fixed wireless signal transceiving devices 102 observed by the wireless signal observation device 107 to the training database 103. Step 602 starts a positioning phase, including: a user activating a positioning program on the mobile wireless signal transceiving device 101 and transmitting wireless signal strength and IMU information at the instant of time to the computing core unit 105 of the server 106; after receiving wireless signal strength and IMU information, the computing core unit 105 performing pre-processing according to the move orientation, whether the device being moving, number of steps and move distance, and so on, in the IMU information. In step 603, after the computing core unit 105 receives the wireless signal strength and IMU information, the computing core unit 105 performs correction on the information of wireless signal strength; then, followed by step 604, performing orientation correction and positioning algorithm on the processed information to identify the location of the user. Finally, as shown in step 605, the identified location is transmitted back to the positioning program on the mobile wireless signal transceiving device 101 for display. It should be noted that the above description does not impose any specific restriction on the methods used to compute information, such as, the orientation, whether the device being moving, number of steps and step size. For example, the amplitude of an axis, such as, pointing towards center of earth, of the IMU information can be used to compute. On the other hand, the positioning algorithm of the present embodiment uses a method of history matching with candidate location set shrinking, which will be described in details momentarily. In the present embodiment, the training phase of step 601 further includes the computing core unit 105 dynamically performing correction on the orientation angle based on the standard orientation angle or the difference between the standard orientation angle and actual measured orientation angle recorded by the mobile wireless signal transceiving device 101 during collecting training data.

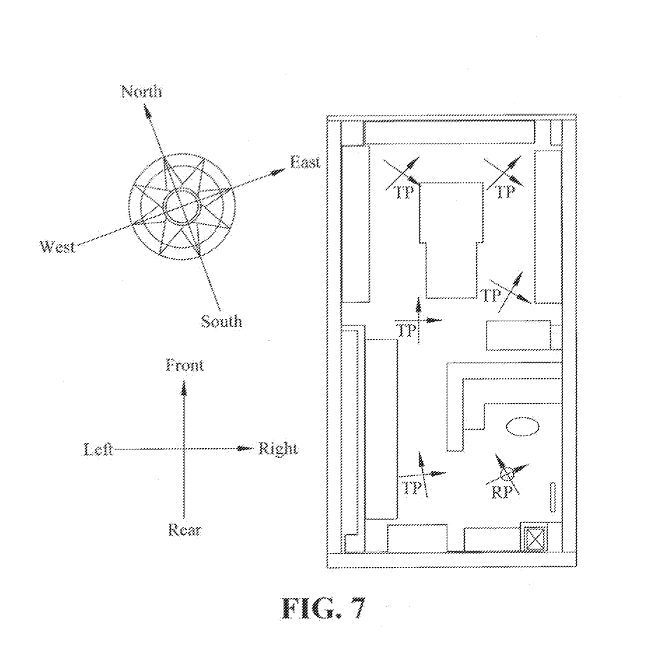

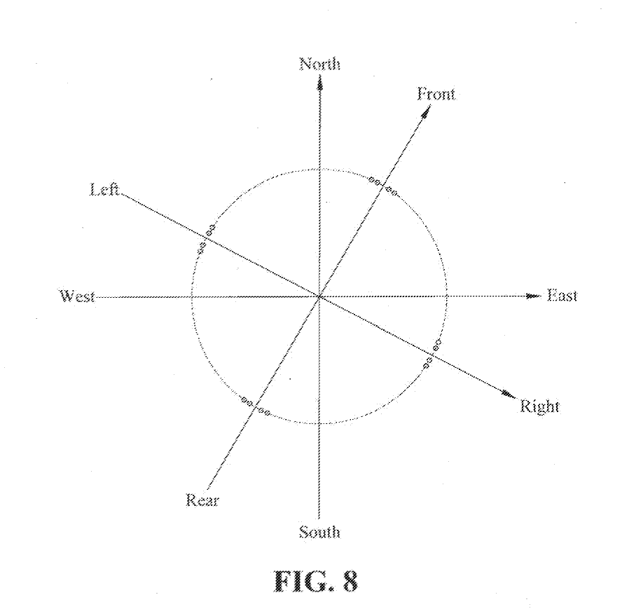

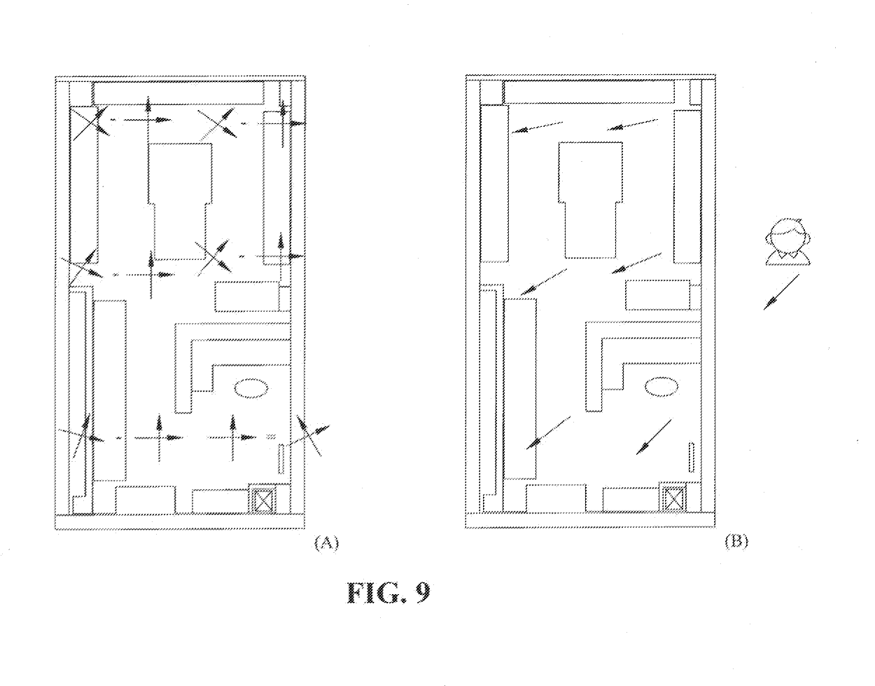

FIG. 7 to FIG. 9 show the computation of defining coordination system of step 610 and orientation correction of step 604. FIG. 7 shows a schematic view of the orientation of the Earth, user-defined orientation and orientation error. FIG. 8 shows a schematic view of computation of axis of user-defined orientation. FIG. 9 shows a schematic view of the orientation correction.

Because the user-defined indoor orientation may not always match the directions of east, west, south and north of the Earth, therefore, a deviation exists between the user-defined orientation and the compass orientation. Besides, as the e-compass uses the geomagnetic in the space to determine the direction and the geomagnetic is prone to indoor interference, such as, motor, metal cabinet, and so on. Furthermore, the interference varies at different locations. Therefore, the unknown indoor environment makes obtaining correct direction solely by e-compass very difficult. As shown in FIG. 7, the e-compass is not always able to measure directions consistent with the actual direction of the Earth at any indoor location.

As the majority of the indoor spaces is rectangular, a person can roughly judge the consistent directions at different locations, for example, by standing at the door facing the window and standing at the window facing the door. Therefore, the present disclosure uses the above characteristic as a guideline for determining the direction, and presents the following means for orientation correction:
1. Select a reference point (RP) as a base. The selection of the RP must be a location with less magnetic interference, as shown in FIG. 7.
2. Define a set of two orthogonal orientation axes, with one as front-rear and the other as left-right (generally related to the orientation of the building). The two orientation axes are not necessarily parallel to the actual orientation axes (i.e., east-west and south-north) of the Earth. In addition, a plurality of measurements of the orientation values is taken and recorded at the RP regarding the defined orientation axes.
3. Based on the plurality of recorded orientation values, use the regression method to obtain and record two axes closest to mutual orthogonality, i.e., the reference orientation axes of the RP, shown as front-rear and left-right axes in FIG. 8. Because these two axes must be orthogonal, rotate one axis for 90°, use a single regression equation to compute the angle of a single axis, and then rotate the angle for 90° in reverse direction to obtain the angle of the other axis.
4. In all the other training positions (TP), also perform a plurality of measurements of the orientation values of the two orientation axes and obtain average values. Then, based on each average value, obtain the difference to the orientation value of the RP at this orientation to obtain individual orientation deviation at each TP.
5. During positioning phase, to perform pattern matching on wireless signal strength of a TP, use the orientation deviation to perform correction to the measured direction in positioning. In addition, the orientation deviation can also be used as an item in pattern matching to be considered with the wireless signal strength in overall pattern deviation.
6. Finally, if the overall pattern deviation of the TP is the smallest, the TP is selected as the identified location, and the orientation correction of the location is the orientation correction result at the instant of time.

The user can also adopt the axes of the Earth for all TPs, including the RP, instead of using the user-defined orientation. The correction result will be equivalent to a multiple of the situation that the angle between the front-rear/left-right orientation axes and the orientation of the Earth is 0° or 90°.

FIG. 9 shows a schematic view of the orientation correction. As shown in FIG. 9A, after selecting reference orientation axes at the RP, the orientation value of measured at the RP is used as the standard orientation value, and the deviation from the orientation value measured at the other TPs is recorded and computed. Then, as shown in FIG. 9B, pattern matching is performed for each candidate position (CP) and the orientation deviation corresponding to the CP is used to perform correction. Finally, the correction result of a CP with smallest pattern distance is selected as the correction result for the orientation or angle.

In step 603 of FIG. 6, the specific embodiment of the signal strength correction is described as follows. Also referring to FIG. 3, the dynamic correction of wireless signal strength is to use a wireless signal observation device 107 to continuously observe the signal strength of the fixed wireless signal transceiving device 102, and transmit the observation result to the computing core unit 105 for processing. After receiving observation result, the computing core unit 105 performs matching the received result against the observation result during training phase, and performs correction the signal strength measured by the mobile wireless signal transceiving device 101 or signal strength recorded in the training database 103 accordingly when the deviation exceeds a specified value. Finally, the computing core unit 105 uses the corrected signal strength for pattern matching to determine the location of the mobile wireless signal transceiving device 101.

The process of the wireless signal correction is as follows:
1. During training phase, the wireless signal observation device 107 records the observed signal strength of the fixed wireless signal transceiving device 102 directly or indirectly into the training database 103. The recorded content can be, such as, the average value of the signal strengths of a fixed wireless signal transceiving device 102 measured by all the wireless signal observation devices 107 within range.
2. During positioning phase, the wireless signal observation device 107 transmits the observed signal strength of the fixed wireless signal transceiving device 102 directly or indirectly to the computing core unit 105 or stores in the training database 103.
3. For each of the fixed wireless signal transceiving device 102, the computing core unit 105 computes the average value of the signal strengths of a fixed wireless signal transceiving device 102 measured by all the wireless signal observation devices 107 within range, and matches against the average value recorded in the training database 103.
4. Based on the matching result, the computing core unit 105 performs dynamic correction on the signal strength measure by the mobile wireless signal transceiving device 101 or the standard signal strength recorded in the training database 103.

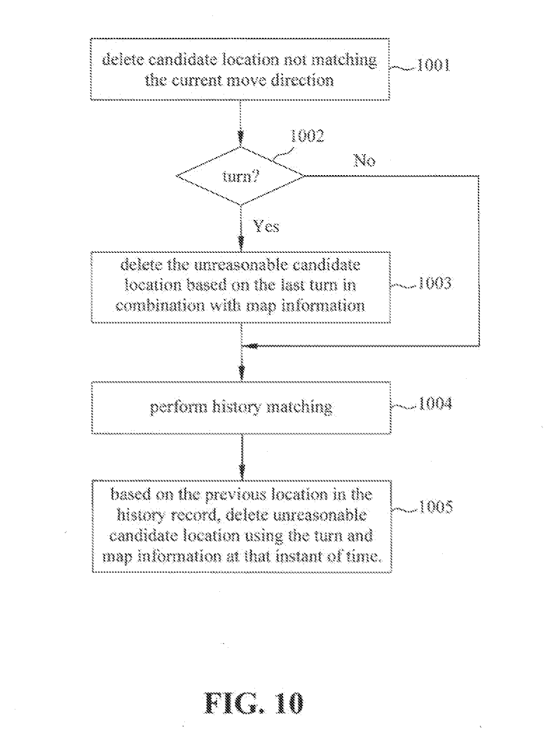

FIG. 10 shows a flowchart of a method of history matching with candidate location set shrinking. This method uses the user's direction of the movement to shrink the candidate location set to further improve accuracy. Step 1001 is to delete candidate locations not matching the current move direction. Step 1002 is to determine whether a turn occurs based on whether the move direction changes. Step 1003 is to delete the unreasonable candidate locations based on the last turn in combination with map information. Step 1004 is to perform matching based on a plurality of signal deviation values in history record. Finally, step 1005 is to backtracking the previous location in the history record and delete unreasonable candidate locations based on the turn and map information at that instant of time.

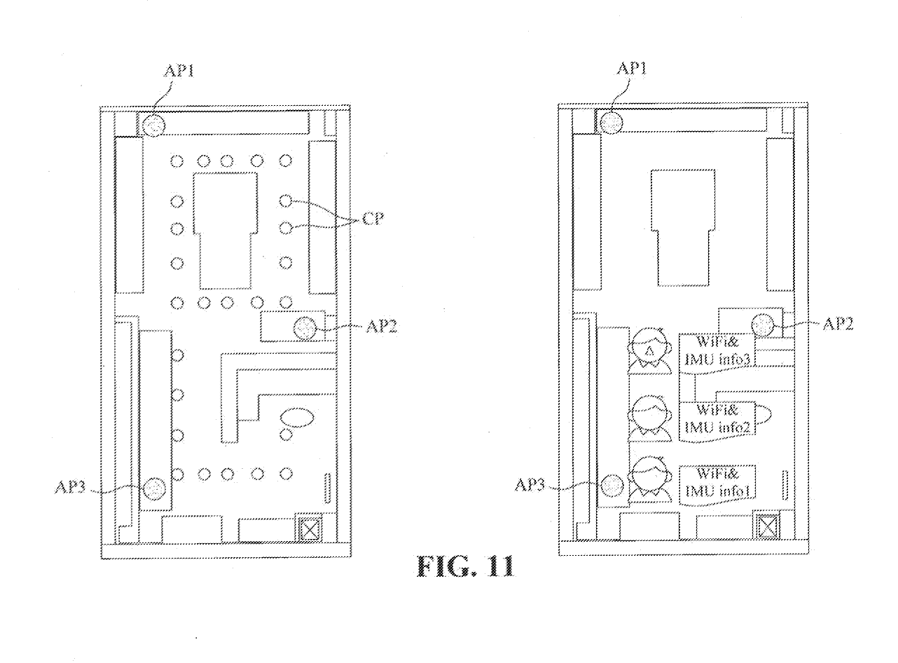

FIG. 11 to FIG. 16 shows an actual process of the method of history matching with candidate location set shrinking of the present disclosure.

FIG. 11 shows a scenario of moving straight forward indoors. Assume that in an indoor environment, three fixed wireless signal transceiving devices AP1, AP2, AP3 are deployed, and 25 TPs are programmed. During the positioning phase, assume that the user enters from the door and walks three steps, with each step transmitting wireless signal three times and IMU information three times to the server, recorded as IMU info 1, IMU info 2 and IMU info 3.

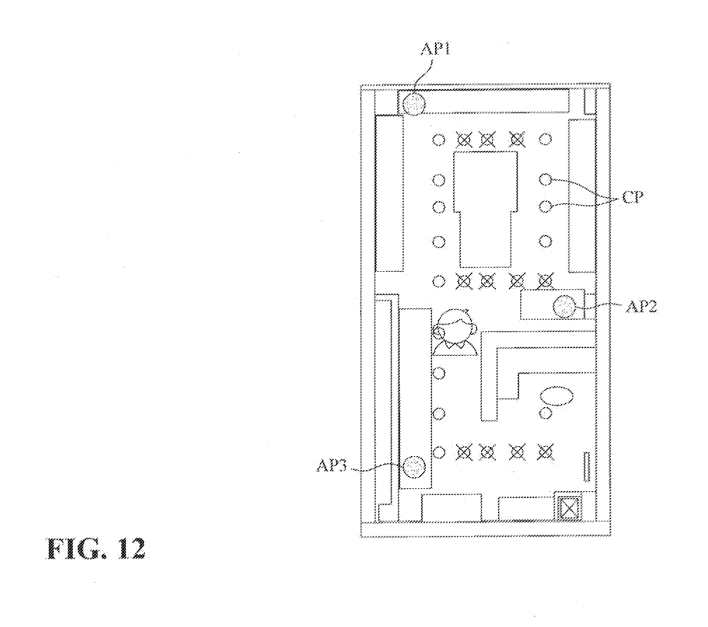

Based on IMU information, the correction is performed on the current orientation based on the angle deviation values corresponding to the all the TPs to obtain all possible current corrected angles. With history record, the user is known to walk from the bottom in FIG. 11 towards the top. Therefore, the CPs not from the bottom towards the top are deleted, shown as the location in the lateral direction in FIG. 12.

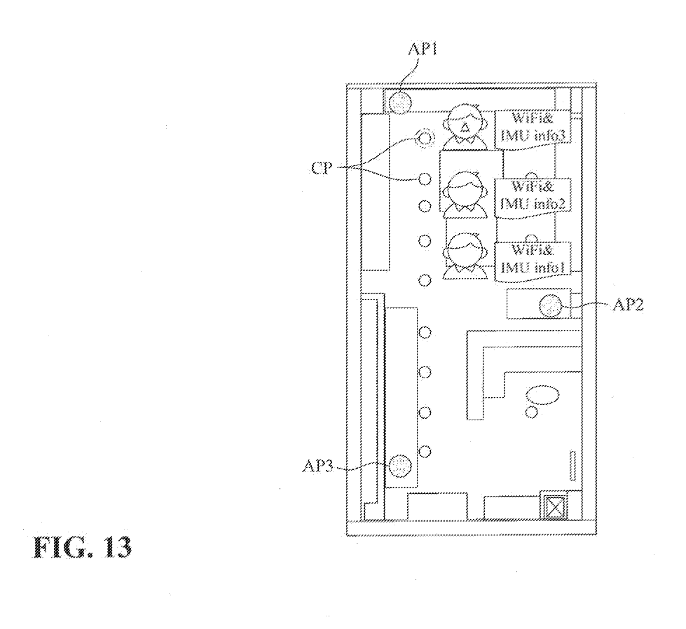

Then, the step is to determine whether a turn has occurred. First, consider the scenario wherein no turn has occurred; in other words, the move direction has not changed in the last time instant or previous steps. When no turn has occurred, the computation of history matching is performed. FIG. 13 shows the computation process of history matching in a scenario of moving straightly, including: computing a pattern distance d1 between each CP and IMU info3; computing a previous location; obtaining the nearest TP; computing a pattern distance d2 between the TP and IMU info2; and computing a pattern distance d3 between a nearest TP of a previous location before the previous location and IMU info 1.

The pattern matching used in the present disclosure is to compute the deviation d between the measured information and training data, and select the most likely candidate based on the smallest deviation. Therefore, for each of the remaining candidates, the candidate location is temporarily assumed to be the location at the instant of time for the user when computing the deviation. Besides, two most likely locations at two previous time points can be computed according to the current candidate location and the displacement of the user. Because the patterns of wireless signals at previous time points and the patterns at the last time point can be changed due to the movement of the user, the distance or deviation computed by using the IMU information can correctly find the target to match. Then, for each of these likely locations, a training location closest to the location is found and deviation d1, d2, d3 are computed. As such, a sum of the deviation d1+d2+d3 for each candidate location can be computed. Finally, the candidate location with the smallest deviation sum is selected as the current location for the user. The result of orientation correction based on the selected location is the current orientation angle.

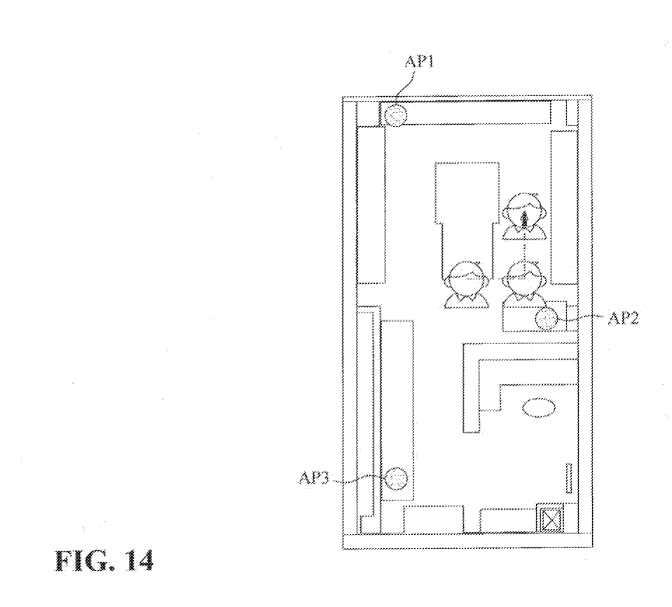

Then, the scenario of the user making a turn is considered. As shown in FIG. 14, when a turn is taken place, the orientation before the turn and the orientation after the turn will be different. Hence, in addition to using the orientation after turning to perform step 1001, the orientation before turning can also be used to delete the candidate locations that cannot be reached by turning from the orientation before turning to the orientation after turning.

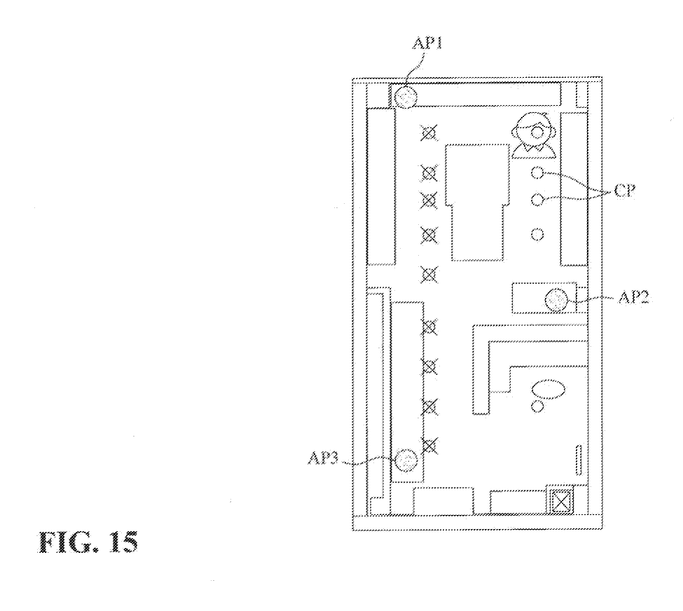

FIG. 15 shows the result after step 1003. Because the user turns from the right side of the map towards the upward direction of the map, the leftmost row of candidate locations can be deleted by step 1003 based on the time point after turning.

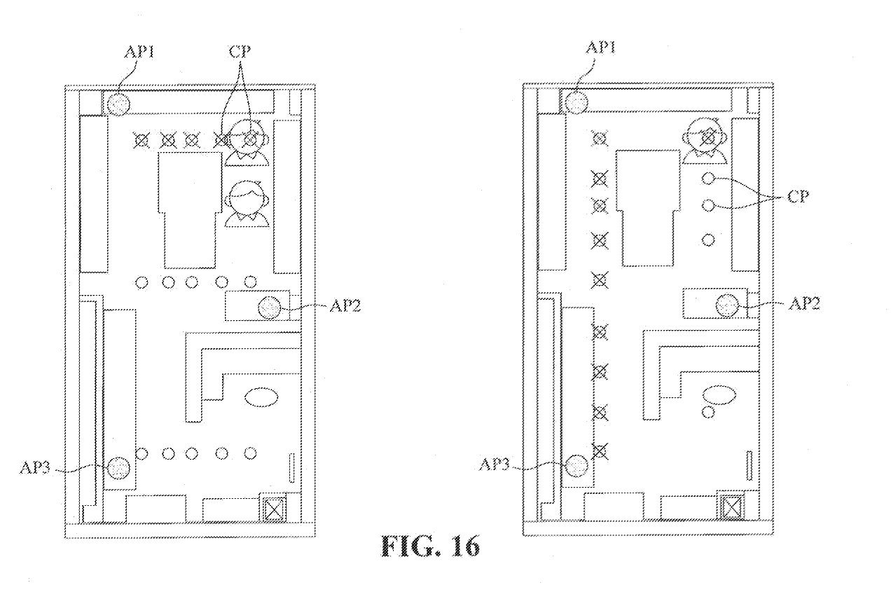

When performing history matching (step 1004), for the time point before turning, the orientation at that time point, as well as a turn is about to take place and the orientation after turning, can be known. By using the above information, step 1005 can perform further deletion of impossible candidate locations. FIG. 16 shows the computation process of history matching (step 1004) and step 1005 in the scenario of turning. Assume that when computing d2, the closest training location is found at the right uppermost location on the map. However, as the next turn is known to be a right turn (towards the lower part of the map), the uppermost row of training locations are impossible to be locations before the turning. Therefore, the current candidate location under matching can be deleted. Finally, after computing and selecting the candidate location with the smallest sum of d1+d2+d3, the result of orientation correction based on the selected location is the current orientation angle.

Compared to conventional technique, the system and method provided in the present disclosure has a correction rate of 89%, as opposed to the 38% by the conventional technique, and the error distance is 0.93 m, as opposed to the 1.72 m by the conventional technique. In other words, the present disclosure outperforms the conventional technique by the improvement of 2.4 times in correction rate and 50% less in error distance.

In summary, the present disclosure provides a system for wireless indoor localization based on IMU and map information, including: at least a mobile wireless signal transceiving device able to execute computation, with each device including with each including at least a wireless signal transceiver and at least an IMU for collecting wireless signal strength measured by the mobile device and information of own movement signal; at least two fixed wireless signal transceiving devices, configured to provide wireless signal for positioning; at least a wireless signal observation device, configured to observe signal strength of fixed signal transceiving devices; at least a training database, configured to store at least a standard comparison information; at least a map information, including indoor spatial description, configured to assist in determining feasibility of movement at continuous time; and at least a computing core unit, configured to compute positioning result based on collected information during training and positioning phases, and comparison with map information.

Accordingly, the present disclosure also provides a method for wireless indoor localization based on IMU and map information, including: a manager establishing map information and programming orientation axis, coordination system and training locations; at each training location, collecting and transmitting wireless signals measured in different directions and IMU information by the mobile wireless signal transceiving device to a training database for recording; and transmitting signal strength of the fixed wireless signal transceiving devices by scanning one another to a computing core; a user activating a positioning program on the mobile wireless signal transceiving device and transmitting wireless signal strength and IMU information at the instant of time to the computing core; after receiving wireless signal strength and IMU information, the computing core unit performing signal correction and displacement detection, and performing orientation correction and positioning algorithm on the processed information to identify the location of the user; and transmitting identified location to the positioning program on the mobile wireless signal transceiving device for display.

It will be apparent to those skilled in the art that various modifications and variations can be made to the disclosed embodiments. It is intended that the specification and examples be considered as exemplary only, with a true scope of the disclosure being indicated by the following claims and their equivalents.

What is claimed is:

1. A system of dynamical correction on wireless signal strength, configured to operate with at least a mobile wireless signal transceiving device with computing capability and wireless signal transceiving capability and a wireless signal observation device, the system comprising:
at least two fixed wireless signal transceiving devices, configured to provide at least a kind of wireless signal to a mobile wireless signal transceiving device and a wireless signal observation device, and to receive at least a wireless signal of the mobile wireless signal transceiving device;
at least a wireless signal observation device, configured to observe signal strength of at least a wireless signal transmitted by the fixed signal transceiving devices;
at least a training database, configured to store at least a standard wireless signal strength; and
at least a computing core unit, configured to perform dynamic correction on signal strength based on the wireless signal strength received by the mobile wireless signal transceiving device, the wireless signal strength observed by the wireless signal observation device before positioning and during positioning, and the standard wireless signal strength being recorded in the training database.

2. The system as claimed in claim 1, wherein the wireless signal is one or any combination of WiFi, Bluetooth, RFID, and Zigbee.

3. The system as claimed in claim 1, wherein the wireless signal observation device is one or any combination of an access point, a router or a tag; and the wireless signal observation device can also be a fixed wireless signal transceiving device configured to provide wireless signals.

4. The system as claimed in claim 1, wherein the training database stores at least a wireless signal strength observed by the wireless signal observation device.

5. The system as claimed in claim 4, wherein the training database stores at least a set of wireless signal strengths based on different times of a day, such as morning, afternoon, and night.

6. The system as claimed in claim 1, wherein the wireless signal strength to be corrected is one or any combination of the standard wireless signal strength recorded in the training database, or wireless signal strength collected by the mobile wireless signal transceiving device during positioning.

7. A method of dynamic correction on wireless signal strength, comprising:
before positioning, at least a wireless signal observation device observing at least a wireless signal transmitted by a fixed wireless signal transceiving device, and storing at least an observation result into a training database; and
when performing positioning, based on at least an observation result of the wireless signal observation device and at least an observation result stored in the training database, a computing core unit performing dynamic correction on at least a wireless signal strength measured by a mobile wireless signal transceiving device or on at least a wireless signal strength stored in the training database.

8. The method as claimed in claim 7, wherein the observation result is further processed in one or any combination of the following manners: stored into the training database by the wireless signal observation device and retrieved from the training database by the computing core unit, transmitted by the wireless signal observation device to the computing core unit, or retrieved from the wireless signal observation device by the computing core unit.

9. A system for wireless indoor localization based on inertial measurement unit (IMU) and map information, configured to operate with at least a mobile wireless signal transceiving device with computing capability and wireless signal transceiving capability, the system comprising:
at least two fixed wireless signal transceiving devices, configured to provide at least a kind of wireless signal to a mobile wireless signal transceiving device and a wireless signal observation device, and to receive at least a wireless signal of the mobile wireless signal transceiving device and at least a measured signal;
at least a training database, configured to store at least a standard matching information;
at least a map information describing an indoor space; and
at least a computing core unit, configured to compute a positioning result based on the wireless signal strength, the measured signal of IMU, the standard matching information recorded in the training database, and the map information.

10. The system as claimed in claim 9, wherein the wireless signal is one or any combination of WiFi, Bluetooth, RFID, and Zigbee.

11. The system as claimed in claim 9, wherein the computing core unit is executing on one or any combination of a server or the mobile wireless signal transceiving device; when executing on the mobile wireless signal transceiving device, the training database and the map information are also stored in the mobile wireless signal transceiving device; and when executing on the server, the training data and the map information are stored on the server.

12. The system as claimed in claim 9, wherein the map information comprises at least a training location, at least a walk-able location, at least a turn-able location, and a turn information at each turn-able location for determining whether a turn at the turn-able location is reasonable.

13. The system as claimed in claim 9, wherein based on a historic pattern and pattern of each candidate location of a candidate location set, the computing core unit further compute an accumulated distance of multiple patterns, and based on a candidate location with a smallest accumulated pattern distance, determines the location of the mobile wireless signal transceiving device.

14. The system as claimed in claim 13, wherein the feature of pattern is one or any combination of the following: a wireless signal strength, an orientation angle, a reading of a magnetometer, a reading of a gyroscope, and a reading of an accelerometer.

15. The system as claimed in claim 14, wherein the wireless signal strength is one or any combination of the following: a result measured by the mobile wireless signal transceiving device measuring the fixed wireless signal transceiving device; a result measured by the fixed wireless signal transceiving device measuring the mobile wireless signal transceiving device; or a result measured by a wireless signal observation device measuring the mobile wireless signal transceiving device.

16. The system as claimed in claim 13, wherein the feature of pattern further comprises one of the following: a measured orientation angle and a standard orientation angle of each training location, or a deviation of these two angles, for correcting angle bias.

17. The system as claimed in claim 13, wherein based on the map information and the pattern, the computing core unit shrinks the candidate location set to improve positioning accuracy.

18. A method for wireless indoor localization based on inertial measurement unit (IMU) and map information, configured to operate with at least a mobile wireless signal transceiving device with computing capability and wireless signal transceiving capability, the method comprising:
collecting at least a wireless signal and at least an IMU signal of the mobile wireless signal transceiving device at least a training location, and storing the at least a wireless signal and the at least an IMU signal in a training database;
receiving at least a wireless signal and at least an IMU signal of the mobile wireless signal transceiving device at a location and transmitting to a computing core unit; and
based on the received wireless signal and IMU signal and the wireless signal and IMU signal stored in the training database, the computing core unit performing sequentially a displacement detection, an orientation correction and a positioning computation to obtain a result of the location.

19. The method as claimed in claim 18, further comprising one of the following: transmitting the result of the location to the mobile wireless signal transceiving device for displaying, or not transmitting the result of the location to the mobile wireless signal transceiving device.

20. The method as claimed in claim 18, further comprising: collecting one of the following: a measured orientation angle and a standard orientation angle of each training location, or a deviation of these two angles, for correcting angle bias, and storing the collected data into the training database.

21. The method as claimed in claim 18, further comprising a step of dynamic correction on wireless signal strength, which comprising:
observing a wireless signal transmitted by at least a fixed wireless signal transceiving device, and storing an observation result into the training database; and
based on received wireless signal and the observation result, performing dynamic correction.

22. The method as claimed in claim 18, wherein the positioning computation is based on a history matching with candidate location set shrinking method.

23. The method as claimed in claim 22, wherein the history matching with candidate location set shrinking method is to compute an accumulated distance of multiple patterns based on a historic pattern and pattern of each candidate location of a candidate location set, and determine the location of the mobile wireless signal transceiving device based on a candidate location with a smallest accumulated pattern distance.

24. The method as claimed in claim 23, wherein the history matching with candidate location set shrinking method further comprises:
based on a characteristic of a movement orientation, deleting candidate locations not matching the characteristic of movement orientation;
based on the IMU signal, determining whether a turn having taken place;
based on a last turn and a map information, deleting candidate locations not matching a scenario involving the last turn and the map information;
based on an accumulated distance of multiple historic patterns, performing matching; and
based on a calculated historic location, a last turn and a next turn for a historic time point, and the map information, deleting candidate locations not matching a scenario involving the calculated historic location, the last turn and the next turn for a historic time point, and the map information.

25. The method as claimed in claim 18, wherein the correction on orientation further comprises:
collecting an expected orientation angle and an actual orientation angle of each training location, or a deviation of these two angles, and storing a result into the training database;
based on the expected orientation angle, the actual orientation angle and the deviation, performing correction on a current orientation angle of the mobile wireless signal transceiving device;
based on corrected angles, performing positioning computation; and
based on a result of computation, selecting a candidate location, and using corresponding corrected values as a correction to the orientation angle of the mobile wireless signal transceiving device.
